(19) United States
(12) Patent Application Publication
(10) Pub. No.: US 2020/0186935 A1
(43) Pub. Date: Jun. 11, 2020

(54) PIEZOELECTRIC LOW-FREQUENCY/HIGH DB ELECTROACOUSTIC ASSEMBLY AND PIEZOELECTRIC SPEAKER APPLYING SAME

(71) Applicant: Changzhou FHD electronics co., LTD, Changzhou (CN)

(72) Inventor: Yin JIANG, Changzhou (CN)

(21) Appl. No.: 16/327,197

(22) PCT Filed: Feb. 20, 2017
(86) PCT No.: PCT/CN2017/074099

§ 371 Date: Feb. 21, 2019

(30) Foreign Application Priority Data
Aug. 23, 2016 (CN) 201610707110.0

(51) Int. Cl. H04R 17/10; H04R 1/28; H04R 1/02

(52) U.S. Cl. CPC H04R 17/10; H04R 1/025; H04R 1/2811

(57) ABSTRACT

The present invention discloses a piezoelectric low-frequency high-dB electroacoustic assembly and a piezoelectric speaker applying the same, belonging to the field of piezoelectric sound-emitting devices. The piezoelectric low-frequency high-dB electroacoustic assembly of the present invention comprises a fixed ring and at least one buzzer set mounted on the fixed ring. Each buzzer set comprises two piezoelectric buzzers disposed in parallel to each other. The two piezoelectric buzzers are separated by a gap. and vibration phases of the two piezoelectric buzzers are the same, and vibration phases of each buzzer set are also the same. By adjusting the gap between the two piezoelectric buzzers in the buzzer set, the resonant frequency and the compliance of the electroacoustic assembly can be adjusted. The present invention further discloses a piezoelectric speaker applying the electroacoustic assembly. By using ordinary piezoelectric buzzers, the present invention can simultaneously meet a requirement for low frequency and high dB performance, and can, if used with an appropriate resonant cavity, meet the requirements of the American UL464 standard.

### TECHNICAL FIELD

The present invention relates to an electroacoustic assembly and a speaker applying the same, and more particularly to a piezoelectric low-frequency high-dB electroacoustic assembly and a piezoelectric speaker applying the same.

### BACKGROUND ART

A piezoelectric ceramic buzzer is a device used in piezoelectric ceramic sheets. Since the human ear is most sensitive to 3 KHz audio signals, the resonant frequency of the buzzer is usually designed to be around 3 KHz during production. The piezoelectric ceramic buzzer has the advantages of high sensitivity, low energy consumption, good stability, high/low temperature resistance, long life, etc., and it has been widely used and matched in electronic clocks, car speakers, audio equipments, communication, remote sensing, calculators, electronic toys and other products.

In an alarm industry for fire alarms, the American UL464 standard requires the frequency of the alarm to be in the low frequency range (around 520 Hz). The additional condition is that the input power is as small as possible, the test distance is 3 m, and the sound pressure is required to be 85 dB (no weighting test), and 520 Hz pure tone of the product is required to be (resonance point F3, F5, F7) at least −5 dB, preferably −20 dB to −30 dB. Since piezoelectric ceramic sheets are generally used for high-frequency devices, if a frequency of 520 Hz is required, ceramic needs to be made very thin. In theory, it can be done, but in actual production, very thin ceramics are easily broken and almost impossible to produce efficiently, so the yield is extremely low. Therefore, so far, the piezoelectric ceramic buzzer has not been used in an alarm conforming to the American UL464 standard. At present, there still employs a 2 W to 3 W speaker to meet the usage requirements, and the energy consumption is high.

In order to improve the low-frequency response of the piezoelectric ceramic buzzer, a conventional method is to adopt a double-diaphragm structure. Chinese patent number ZL200820032820.9 was authorized on Mar. 11, 2009, entitled “PIEZOELECTRIC CERAMIC VOICE DRIVING DEVICE”. This application relates to an generating device for an alarm for fire fighting and the like, which comprises at least two layers of piezoelectric ceramic sheets, where the piezoelectric ceramic sheet has a radius of no less than 15 mm and a thickness of no more than 0.15 mm, the upper and lower surfaces of each layer of the piezoelectric ceramic sheets are disposed with a conductive cloth, and the piezoelectric ceramic sheet and the conductive cloth are bonded by a glue layer. This application uses at least two layers of piezoelectric ceramic sheets and conductive cloths as a voice driving device. Although the frequency is effectively reduced, due to the limitations of its structural design, it is still unable to meet the requirements of low frequency and high dB at the same time, so it cannot really meet the American UL464 standard.

### SUMMARY

### 1. Technical Problems to be Solved by the Invention

The object of the present invention is to overcome the disadvantages that existing piezoelectric ceramic sheets and assemblies thereof are difficult to meet the low frequency and high dB sound requirements and especially fail to meet the requirements of the American UL464 standard of an alarm, and to provide a piezoelectric low-frequency high-dB electroacoustic assembly and a piezoelectric speaker applying the same. By using the technical solution of the present invention, ordinary piezoelectric buzzers can be utilized to simultaneously meet the requirements of low frequency and high dB, and if used with an appropriate resonant cavity, can meet the requirements of the American UL464 standard.

### 2. Technical Solution

In order to achieve the above object, the technical solution provided by the present invention is as follows:

A piezoelectric low-frequency high-dB electroacoustic assembly of the present invention comprises a fixed ring and at least one buzzer set mounted on the fixed ring, where each buzzer set comprises two piezoelectric buzzers disposed in parallel to each other, the two piezoelectric buzzers are separated by a gap, and vibration phases of the two piezoelectric buzzers are the same, and vibration phase of each buzzer set are also the same.

Further, by adjusting the gap between the two piezoelectric buzzers in the buzzer set, the resonant frequency and the compliance of the electroacoustic assembly can be adjusted.

Further, the inner side wall of the fixed ring is provided with a boss, the two piezoelectric buzzers in the buzzer set are oppositely fixed on two sides of the boss, and the height of the boss is the gap between the two piezoelectric buzzers.

Further, the piezoelectric buzzers are bonded and fixed on the boss of the fixed ring.

A piezoelectric speaker of the present invention comprises a resonant cavity, and further comprises the above electroacoustic assembly, where the electroacoustic assembly is mounted in the resonant cavity through a fixed ring.

### 3. Beneficial Effects

Compared with the prior art, the technical solution provided by the present invention has the following remarkable effects:

(1) the piezoelectric low-frequency high-dB electroacoustic assembly and the piezoelectric speaker applying the same, by disposing at least one buzzer set comprising two piezoelectric buzzers having a certain gap and the same vibration phase on the fixed ring, can utilize ordinary piezoelectric buzzers to simultaneously meet the requirements of low frequency and high dB, and if used with an appropriate resonant cavity, can meet the requirements of the American UL464 standard;

(2) the piezoelectric low-frequency high-dB electroacoustic assembly of the present invention, which by adjusting the gap between the two piezoelectric buzzers in the buzzer set, the resonant frequency and the compliance of the electroacoustic assembly can be adjusted, can be used in the 20 Hz to 1 KHz occasions, and has a wide application range;

(3) according to the piezoelectric low-frequency high-dB electroacoustic assembly of the present invention, the inner side wall of the fixed ring is provided with a boss, the two piezoelectric buzzers in the buzzer set are oppositely fixed on two sides of the boss, and the height of the boss is the gap between the two piezoelectric buzzers, so the piezoelectric buzzers can be positioned and fixed on the fixed ring conveniently and the manufacture is simpler; and

(4) according to the piezoelectric speaker applying the electroacoustic assembly of the present invention, the electroacoustic assembly is mounted in the resonant cavity through the fixed ring, so the manufactured piezoelectric alarm and piezoelectric speaker have an excellent bass effect, especially have reached the American UL464 standard, and they only need 0.5 W power to replace the existing 2 W to 3 W speaker, thereby greatly reducing the energy consumption and having good application prospects.

### BRIEF DESCRIPTION OF THE DRAWINGS

FIG. 1 is a schematic structural view of a piezoelectric low-frequency high-dB electroacoustic assembly according to the present invention;

FIG. 2 is a partial enlarged structural view of portion K in FIG. 1; and

FIG. 3 is a schematic structural view of a piezoelectric speaker applying the above electroacoustic assembly according to the present invention.

### DESCRIPTION OF NUMERALS IN THE FIGURES

1, fixed ring; 1-1, boss; 2, piezoelectric buzzer; 3, resonant cavity.

### DETAILED DESCRIPTION

In order to further understand the present invention, the present invention will be described in detail with reference to the accompanying drawings.

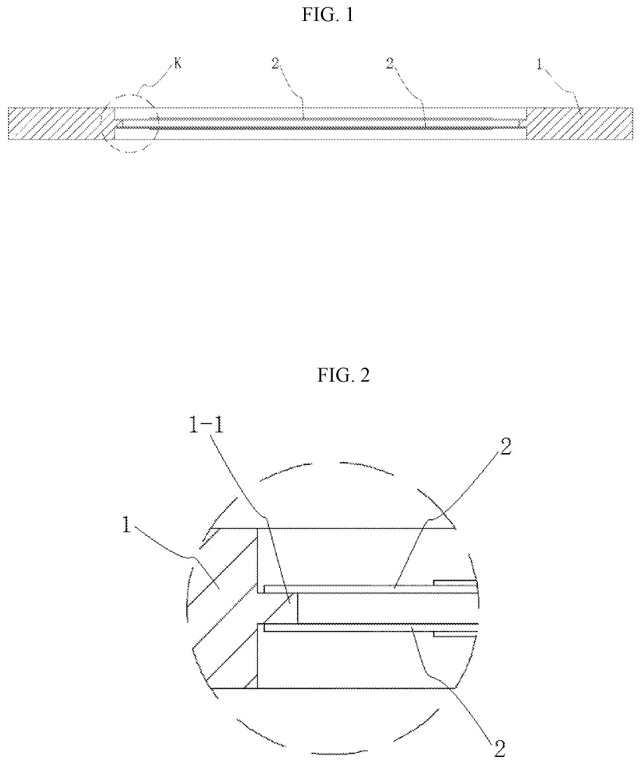

As shown in FIG. 1, a piezoelectric low-frequency high-dB electroacoustic assembly of the present invention comprises a fixed ring 1 and at least one buzzer set mounted on the fixed ring 1, where each buzzer set comprises two piezoelectric buzzers 2 disposed in parallel to each other. The two piezoelectric buzzers 2 are separated by a gap, and vibration phases of the two piezoelectric buzzers 2 are the same, and vibration phases of each buzzer set are also the same. The resonant frequency and the compliance of the electroacoustic assembly are adjustable by adjusting the gap between the two piezoelectric buzzers 2 in the buzzer set. As shown in FIG. 2, the inner side wall of the fixed ring 1 is provided with a boss 1-1, the two piezoelectric buzzers 2 in the buzzer set are oppositely fixed on two sides of the boss 1-1, and the height of the boss 1-1 is the gap between the two piezoelectric buzzers 2; and the piezoelectric buzzers 2 are bonded and fixed on the boss 1-1 of the fixed ring 1. According to the piezoelectric low-frequency high-dB electroacoustic assembly of the present invention, on the basis of the theory of increasing the power by electrically connecting the piezoelectric buzzers in parallel and the electroacoustic theory that the resonant frequency of the system can be reduced by changing the compliance of the acoustic system, the two ordinary piezoelectric buzzers 2 having a certain gap and the same vibration phase can be utilized to simultaneously meet the requirements of low frequency and high dB. When higher power and louder sounds are needed, these can be achieved by increasing the number of buzzer sets.

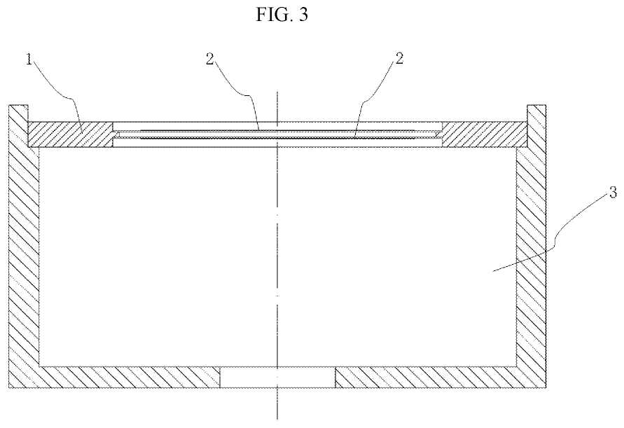

As shown in FIG. 3, a piezoelectric speaker of the present invention comprises a resonant cavity 3 and the above electroacoustic assembly, where the electroacoustic assembly is mounted in the resonant cavity 3 through the fixed ring 1. The manufactured piezoelectric alarm and piezoelectric speaker have an excellent bass effect, especially have reached the American UL464 standard, and they only need 0.5 W power to replace an existing 2 W to 3 W speaker, thereby greatly reducing the energy consumption and having good application prospects.

The present invention will now be further described in conjunction with the examples.

### Examples

One buzzer set is taken as an example. As shown in FIG. 1, a piezoelectric low-frequency high-dB electroacoustic assembly of the present embodiment comprises a fixed ring 1 and one buzzer set mounted on the fixed ring 1. The buzzer set comprises two piezoelectric buzzers 2 disposed in parallel to each other, and the two piezoelectric buzzers 2 are separated by a gap. By adjusting the gap between the two piezoelectric buzzers 2, the resonant frequency and the compliance of the electroacoustic assembly can be adjusted. And the two piezoelectric buzzers 2 have the same vibration phase, and the two piezoelectric buzzers 2 are connected in parallel. The interaction between two piezoelectric buzzers 2 having the same vibration phase increases the power of the electroacoustic assembly and reduces the resonance frequency. The ordinary piezoelectric buzzers 2 can be utilized to simultaneously meet the requirements of low frequency and high dB, so the electroacoustic assembly can be used in the 20 Hz to 1 KHz occasions and has a wide application range.

As shown in FIG. 2, the inner side wall of the fixed ring 1 is provided with a boss 1-1, the two piezoelectric buzzers 2 in the buzzer set are oppositely fixed on two sides of the boss 1-1, and the height of the boss 1-1 is the gap between the two piezoelectric buzzers 2; and particularly, the piezoelectric buzzers 2 are bonded and fixed on the boss 1-1 of the fixed ring 1, so the piezoelectric buzzers 2 can be positioned and fixed on the fixed ring 1 conveniently and the manufacture is simpler.

In the case where higher power and louder sound are needed, it is only required to increase buzzer sets in pairs, so the structure is simple and the manufacture is convenient.

With the above electroacoustic assembly, a piezoelectric speaker or a piezoelectric alarm can be manufactured by a conventional method in combination with a suitable cavity. As shown in FIG. 3, the piezoelectric speaker of this embodiment comprises a resonant cavity 3 and the above electroacoustic assembly, where the electroacoustic assembly is mounted in the resonant cavity 3 through the fixed ring 1. The experiment shows that the manufactured piezoelectric alarm and piezoelectric speaker have a very good bass effect, especially have reached the American UL464 standard when the gap between the two piezoelectric buzzers 2 is adjusted to a suitable size, and only need 0.5 W power to replace an existing 2 W to 3 W speaker, thereby greatly reducing the energy consumption and having good application prospects.

According to the piezoelectric low-frequency high-dB electroacoustic assembly and the piezoelectric speaker applying the same, by disposing at least one buzzer set including two piezoelectric buzzers having a certain gap and the same vibration phase on the fixed ring, can utilize the common piezoelectric buzzers to simultaneously meet the requirements of low frequency and high dB, and if matching with a suitable resonant cavity, can meet the requirements of the American UL464 standard; and the electroacoustic assembly and the piezoelectric speaker applying the same can be applied to any occasion where a 20 Hz to 1 KHz bass device is required to be manufactured using piezoelectric ceramics.

The present invention and its implementations are schematically described above, and the description is not limiting. What are shown in the drawings are only one of the implementations of the present invention, and the actual structure is not limited thereto. Therefore, if the structural forms and embodiments similar to the technical solution are not creatively designed by a person of ordinary skill in the art without departing from the spirit and scope of the present invention, they should belong to the protection scope of the present invention.

1. A piezoelectric low-frequency high-dB electroacoustic assembly, comprising a fixed ring and at least one buzzer set mounted on the fixed ring, wherein each buzzer set comprises two piezoelectric buzzers disposed in parallel to each other, the two piezoelectric buzzers are separated by a gap, and vibration phases of the two piezoelectric buzzers are the same, and vibration phases of each buzzer set are also the same.

2. The piezoelectric low-frequency high-dB electroacoustic assembly according to claim 1, wherein by adjusting the gap between the two piezoelectric buzzers in the buzzer set, the resonant frequency and the compliance of the electroacoustic assembly can be adjusted.

3. The piezoelectric low-frequency high-dB electroacoustic assembly according to claim 2, wherein the inner side wall of the fixed ring is provided with a boss, the two piezoelectric buzzers in the buzzer set are oppositely fixed on two sides of the boss, and the height of the boss is the gap between the two piezoelectric buzzers.

4. The piezoelectric low-frequency high-dB electroacoustic assembly according to claim 3, wherein the piezoelectric buzzers are bonded and fixed on the boss of the fixed ring.

5. A piezoelectric speaker, comprising a resonant cavity and further comprising the electroacoustic assembly according to claim 1, wherein the electroacoustic assembly is mounted in the resonant cavity through a fixed ring.

6. A piezoelectric speaker, comprising a resonant cavity and further comprising the electroacoustic assembly according to claim 2, wherein the electroacoustic assembly is mounted in the resonant cavity through a fixed ring.

7. A piezoelectric speaker, comprising a resonant cavity and further comprising the electroacoustic assembly according to claim 3, wherein the electroacoustic assembly is mounted in the resonant cavity through a fixed ring.

8. A piezoelectric speaker, comprising a resonant cavity and further comprising the electroacoustic assembly according to claim 4, wherein the electroacoustic assembly is mounted in the resonant cavity through a fixed ring.
